(19) United States
(12) Patent Application Publication
(10) Pub. No.: US 2012/0098989 A1
(43) Pub. Date: Apr. 26, 2012

(54) IMAGING APPARATUS AND METHOD OF DISPLAYING A NUMBER OF CAPTURED IMAGES

(76) Inventor: Wataru SUGAWARA, Kanagawa (JP)

(21) Appl. No.: 13/223,743

(22) Filed: Sep. 1, 2011

(30) Foreign Application Priority Data
Oct. 20, 2010 (JP) 2010-235553
Mar. 1, 2011 (JP) 2011-043707

(51) Int. Cl. H04N 5/228

(52) U.S. Cl. 348/222.1; 348/E05.031

(57) ABSTRACT

An imaging apparatus includes an image capturing unit that capture image data, a display that displays the image data, a calendar that provides current time and date information, and a determination unit that classifies the image data by determining which one of plural different scene categories corresponds to the image data. The apparatus also includes a count unit that obtains the current time and data information from the calendar, adds the image data to the time and date information and increments a number of images captured today corresponding to the scene category classified by the determination unit when a date of a currently captured image data is the same as a date in a previously captured image data. A display unit displays, on the display, the number of images captured today corresponding to each of the plural different scene categories.

### CROSS REFERENCE TO RELATED APPLICATIONS

This application claims the benefit of priority under 35 USC §119 from Japanese Patent Application No. 2010-235553, filed Oct. 20, 2010, and Japanese Patent Application No. 2011-043707, filed Mar. 1, 2011, the entire contents of which are incorporated herein by reference.

### BACKGROUND OF THE INVENTION

1. Field of the Invention

The present invention relates to an imaging apparatus and a method of displaying the number of capturing.

2. Description of the Related Art

Image data captured by a digital camera captured includes digital data, which is conventionally handled by a computer, such as a personal computer (PC). Time and day information may be automatically added to the image data, and hence users can know easily when the corresponding image data was captured. However, large amounts of image data are stored in a memory, and it may be difficult for users to know how many photos were captured during a predetermined period of time.

Some photo enthusiasts and amateurs practice photography based on how many pictures of different types they capture, and they desire to know how many images are captured during various periods of time. Also, users change parameters, such as shutter speed and white balance, for example, AWB (automatic white balance), corresponding to a subject. Users may also desire to know how many images are captured for different scenes during different periods of time.

Therefore, a technology that provides when and how many photos were captured in a year is known.

(For example, see Japanese Publication No. 2007-293385) Japanese Publication No. 2007-293385 discloses an image processing apparatus that calculates distributions of a number of captured images by capturing dates, displays the distributions on a display screen, and shows changes in the number of captured images by use of hue changes or contrast changes of a specific color.

However, the image processing apparatus of Japanese Publication No. 2007-293385 shows approximately a number of images captured during a predetermined period of time using a graph, and therefore users cannot know the total number of images captured during the period of time.

Also, the image processing apparatus of Japanese Publication No. 2007-293385 can extract image data from images captured in the same season and the same location (For example, a cherry blossom season or a winter season). But image data from images captured in the same season also includes image data from images captured indoors, images captured outdoors, images captured of persons, and images captured of sports scenes, for example. Therefore, if the image processing apparatus extracts image data by use of a season or a period of time, there is a problem of not being able to extract image data of each scene. In other words, when users practice photography based on a number of pictures captured of each type, it is difficult for the users to know the number of pictures captured, not only based on period of time during which it was captured, but also based on the scene category of the picture. Furthermore, it is difficult for users to know how many pictures are captured for each scene type.

### BRIEF SUMMARY

It is an object of the present invention to at least partially solve the problems in the conventional technology.

According to an aspect of the present invention, there is provided an imaging apparatus and a method of displaying a number of captured images that can display the number of images captured in each of plural different scene categories, and for plural different periods of time.

In particular, one embodiment of the present invention provides an imaging apparatus including an image capturing unit that captures image data, a display that displays the image data, a calendar that provides current time and date information, a determination unit that classifies the image data by determining which one of plural different scene categories corresponds to the image data, a count unit that obtains the current time and date information from the calendar, adds the image data to the time and date information and increments a number of images captured today corresponding to the scene category classified by the determination unit when a date of a currently captured image data is the same as a date of a previously captured image data, and a display unit that displays, on the display, the number of images captured today corresponding to each of the plural different scene categories when a predetermined operation is performed.

Also, an embodiment of the present invention provides a method of displaying a number of captured images, that includes capturing image data by an image capturing unit, displaying the image data by a display, providing current time and date information by a calendar, and classifying the image data and determining which one of plural different a scene categories corresponds to the image data by a determination unit. The method also includes obtaining the current time and date information from the calendar, adding the image data to the time and date information and incrementing, by a count unit, a number of images captured today corresponding to the scene category classified by the determination unit when a date of a currently captured image data is the same as a date in a previously captured image data. In addition, the method includes displaying, by a display unit, the number of images captured today corresponding to each of the plural different scene categories on the display when a predetermined operation is performed.

### BRIEF DESCRIPTION OF THE DRAWINGS

FIG. 1 illustrates a schematic diagram showing an example of displaying the number of capturing of a digital camera;

FIG. 2A illustrates a schematic diagram showing a front view of the appearance of a digital camera,

FIG. 2B illustrates a schematic diagram showing a back view of the appearance of a digital camera and

FIG. 2C illustrates a schematic diagram showing a top view of the appearance of a digital camera;

FIG. 3 illustrates a block diagram showing the hardware configuration of a digital camera;

FIG. 4A and FIG. 4B illustrate diagrams showing examples of a capturing mode of a digital camera;

FIG. 5A and FIG. 5B illustrate diagrams showing examples of a capturing mode of a digital camera;

FIG. 6 illustrates a block diagram showing the function of a digital camera;

FIG. 7A and FIG. 7B are flowcharts illustrating examples of a scene determination function of a digital camera;

FIG. 8 is a flowchart illustrating an example of displaying a number of images captured in one day;

FIGS. 9A to 9E illustrate diagrams showing examples of count values in a memory;

FIG. 10 is a flowchart illustrating another example of displaying the number of images captured in one day;

FIG. 11 illustrates a diagram showing an example of a screen which sets time periods for counting the number of captured images;

FIG. 12 is a flowchart illustrating another example of displaying the number of images captured in one day;

FIGS. 13A to 13C illustrate schematic diagrams showing other examples of displaying the number of images captured by a digital camera;

FIG. 14 is a flowchart illustrating another example of displaying the number of images captured in one day;

FIG. 15 illustrates a schematic diagram showing another example of displaying the number of images captured by a digital camera;

FIGS. 16A to 16C illustrate schematic diagrams showing other examples of displaying the number of images captured by a digital camera;

### DETAILED DESCRIPTION

Hereinafter, an embodiment of an imaging apparatus and a method of displaying a number of captured images according to the present invention will be described with reference to the drawings.

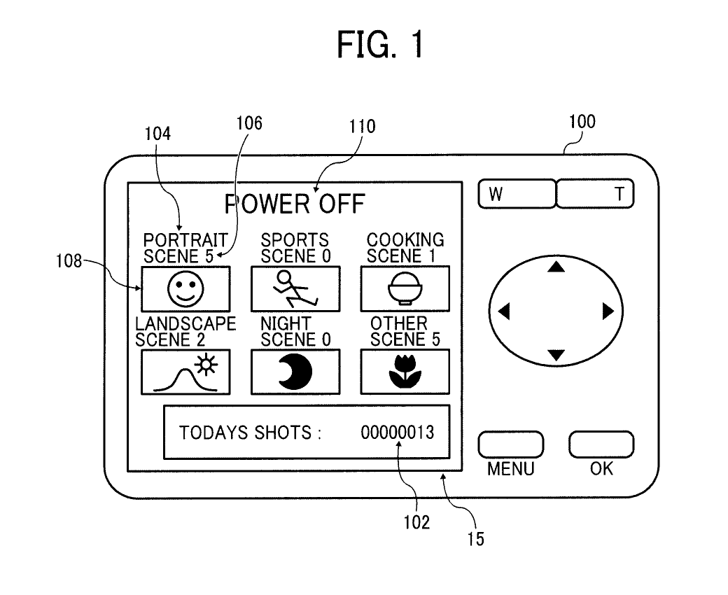

FIG. 1 is a schematic diagram showing an example of displaying a number of images 102 captured during the current day (i.e., “TODAY”) by a digital camera 100. FIG. 1 also shows the numbers of images 106 captured during the current day in each of plural different scene categories on a screen, such as an LCD 15, on the back face of the digital camera 100. In particular, FIG. 1 shows for each scene category, an icon 108, which represents the scene category, and a scene name 104. In this example, during the current day, five portrait photos were captured, zero sports photos were captured, one cooking photo was captured, two landscape photos were captured, zero night scene photos were captured, and five photos were captured in the other scene category.

Also, the digital camera 100 can show the number of images captured in each scene category for various other periods of time. For example, the digital camera 100 can show the number of images captured during one day, one week, one month, or a total number of images captured from the time of purchase to the current time. Therefore, users can easily know the number of images captured in each scene category during a user selectable period of time, such as one day.

Also, as shown in FIG. 1, a “POWER OFF” indication 110 is displayed on the screen, and the digital camera 100 shows the number of captured images every time the user powers off the digital camera 100. Therefore, the digital camera 100 can display the number of captured images for each scene category without requiring particular operations to know the number of captured images. In addition, when a user would like to know the number of captured images, the digital camera 100 can display the number of captured images for each scene category when the user performs a particular operation in a play mode.

In this way, by use of the digital camera 100, users can intuitively know the number of images captured for each scene category in a predetermined period of time without cumbersome manual operations, such as, for example, counting the number of images captured for each scene category manually.

### The First Embodiment

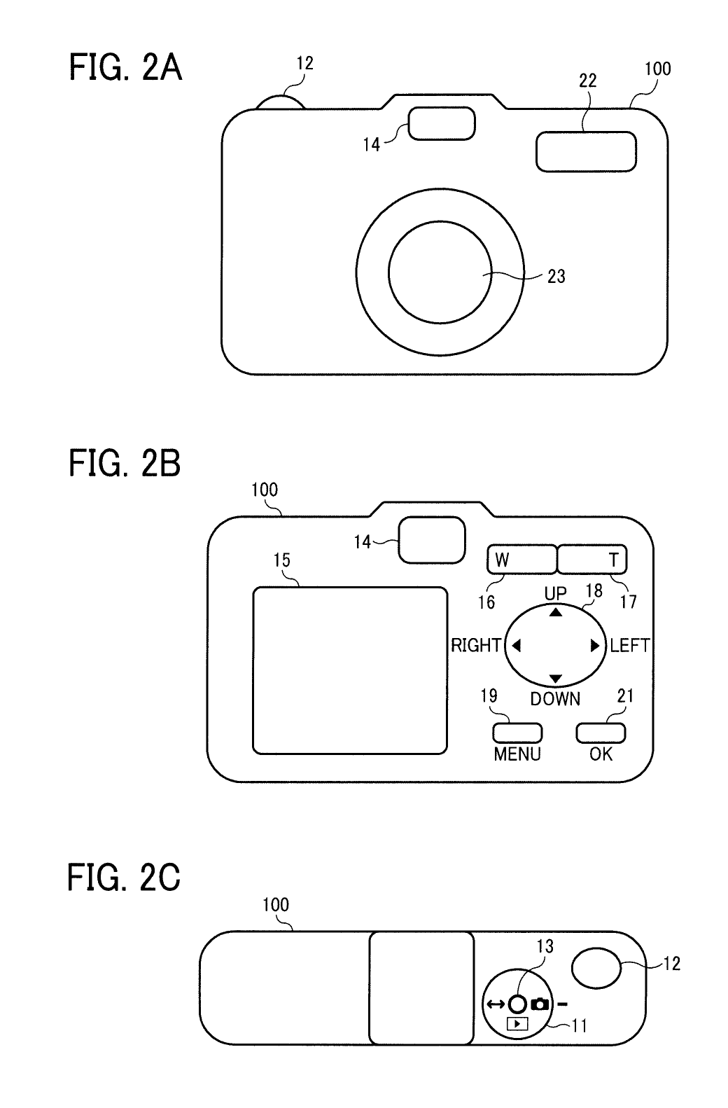

FIGS. 2A to 2C are schematic diagrams showing the appearance of the digital camera 100. FIG. 2A shows a front view of the digital camera 100, FIG. 2B shows a back view, and FIG. 2C shows a top view. The digital camera 100 is an example of an imaging apparatus. The imaging apparatus is equipped to capture still images or moving images and can display the number of still or moving images captured. For example, the digital camera 100 may be a compact digital camera or a single-lens reflex camera. Other examples of the imaging apparatus according to the present invention include a digital video camera, a mobile phone, and a smart phone.

The digital camera 100 includes a capture/play switching dial 11, a release button 12, a power button 13, an optical finder 14, an LCD 15, a wide button 16, a tele button 17, an adjust button 18, a menu button 19, an OK button 21, a flash 22, and an imaging lens 23.

The capture/play switching dial 11 is a dial which switches to a capturing mode or a play mode. The release button 12 is a button which captures still images or moving images. The optical finder 14 is a finder for seeing a subject through a transparent glass or a plastic. The LCD 15 may display a captured still image, a captured moving image, and a menu screen, and may also display an electric view finder before capturing. The wide button 16 and the tele button 17 are buttons which indicate directions for shrinking or expanding of an optical zoom. By pushing down the wide button 16, the imaging lens 23 zooms down. By pushing down the tele button 17, the imaging lens 23 zooms up. The adjust button 18 is a button to control a user operation. The adjust button 18 is used for moving a menu cursor and selecting image data on the LCD 15. The menu button 19 is a button which causes a menu screen to be displayed on the LCD 15. The OK button 21 is a button which determines a user's selection. The flash 22 is a source for lighting a subject. The imaging lens 23 includes plural lenses which form an image of a subject.

If the user turns the capture/play switching dial 11 to a position showing a camera icon, the digital camera 100 switches to a capturing mode. If the user turns the capture/play switching dial 11 to a position showing a triangle symbol, the digital camera 100 switches to a play mode. In particular, if a user turns the capture/play switching dial 11 to the position showing the camera icon and pushes the power button 13, which is in the center of the capture/play switching dial 11, the digital camera 100 starts in a play mode.

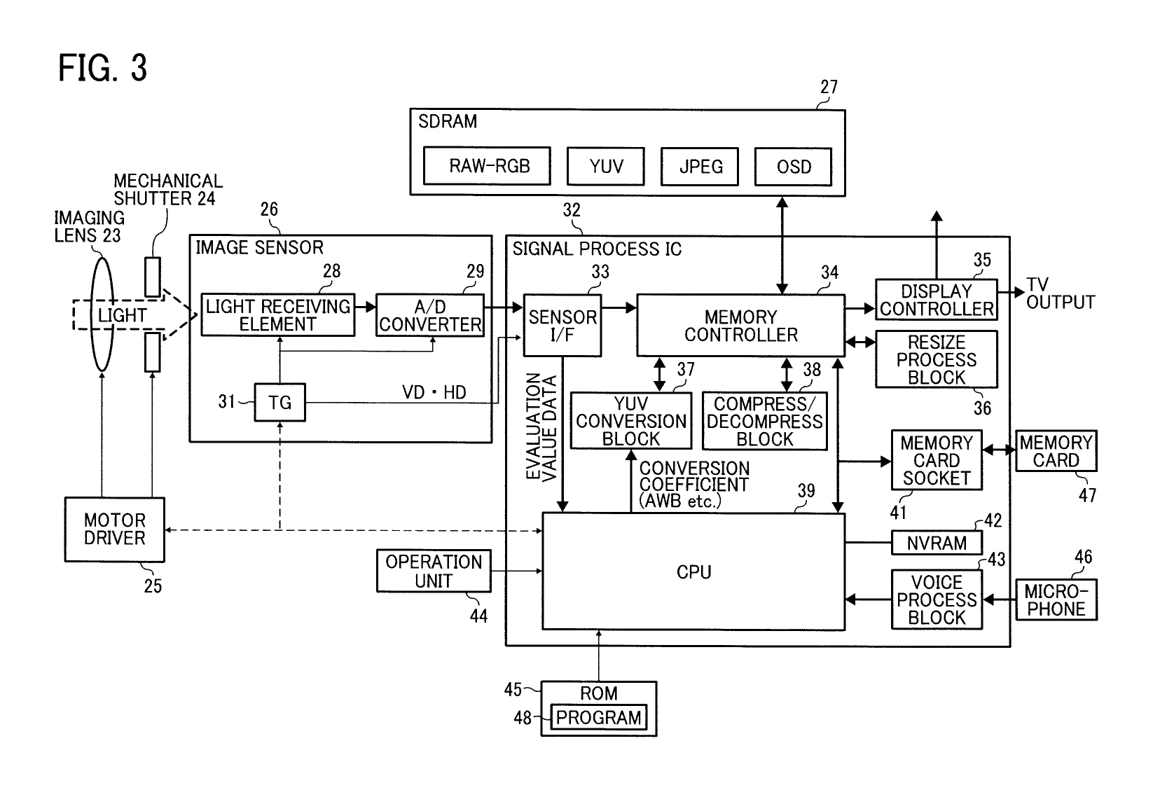

FIG. 3 illustrates a block diagram showing a hardware configuration of the digital camera 100. In FIG. 3, the same parts as FIGS. 2A to 2C are given the same number, and descriptions about the same number will be skipped. The digital camera 100 includes the imaging lens 23, a mechanical shutter 24, a motor driver 25, an image sensor 26, a signal process IC 32, an operation unit 44, a ROM 45, and a SDRAM 27.

The signal process IC 32 has a sensor I/F 33, a memory controller 34, a display controller 35, a resize process block 36, a YUV conversion block 37, a compress/decompress block 38, a CPU 39, a memory card socket 41, a NVRAM (non volatile RAM) 42, and a voice process block 43.

The operation unit 44 corresponds to the various buttons shown in FIGS. 2A to 2C and the menu screen on the LCD 15. The ROM 45 stores programs which are, for example, OS (operation system), a initialization process of OS, a process for moving the imaging lens 23 when starting up, a initialization process of a memory card 47, a process for controlling each part of the digital camera 100 corresponding to operations by users. The SDRAM 27 is a volatile memory which temporally stores image data, and stores image data of RAW-RGB format, YUV format, and JPEG format. Image data is stored in the memory card 47 or the NVRAM 42.

The motor driver 25 drives the imaging lens 23 based on the controls of the CPU 39, and moves the imaging lens 23 in a direction of the light axis for focusing or zooming. The digital camera 100 has an electrical shutter which reads out electrical charge from the image sensor 26 in each exposure time. The mechanical shutter 24 shuts off a light toward the electrical shutter in outside exposure times.

The image sensor 26 has a light receiving element 28, an A/D converter 29, and a TG (timing generator) 31. The light receiving element 28 is a CCD or a CMOS, and has a CDS (correlated double sampling) block or an AGC (automatic gain control) block. The TG 31 generates VD (vertical drive) signals and HD (horizontal drive) signals based on clock signals, and inputs VD signals and HD signals to the sensor I/F 33.

Next, when the power button 13 is pushed, an operation of a finder mode starts. In the finder mode, a light incoming to the light receiving element 28 via the imaging lens 23 is converted to electrical signals, and the electrical signals are output to the A/D converter 29. The A/D converter 29 converts analog signals output by the light receiving element 28 to digital signals in 12 bit. Digital signals converted by A/D converter 29 are output to the sensor I/F 33.

The sensor I/F 33 determines a timing for transferring image data as digital signals converted by A/D converter 29. Then, image data is com posed of RGB signals in a digital format. Also, the sensor I/F 33 calculates an AF (automatic focus) evaluation value which shows a degree of focusing, an AE (automatic exposure) evaluation value which detects a subject brightness, and an AWB (automatic white balance) evaluation value which detects a subject color or a light source color, based on RGB signals. These evaluation values are output to the CPU 39, and used to perform processes of AE, AF or AWB.

The AF evaluation value is calculated, for example, using a value of an integral output by a high-frequency component extraction filter and values of an integral of brightness differences between close pixels. In a state of coming into focus, high-frequency components hit a peak because edges of a subject become clear. When the digital camera 100 is focusing in AF process, the CPU 39 receives the AF evaluation value of each focus lens position from the sensor I/F 33, and determines a focus lens position at which the high-frequency components hit a peak as the in focus position.

The AE evaluation value and the AWB evaluation value are each calculated using values of integrals of the RGB signals. The AE process is as follows. For example, the sensor I/F 33 divides an image area into 1024 smaller areas (for example, 32 areas across the horizontal direction of the image area and 32 areas across the vertical direction of the image area), and calculates integrated values of RGB signals of each area. The CPU 39 inputs the value of an integral of the RGB signals from the sensor I/F 33, calculates a brightness of each area, and determines an appropriate exposure time based on a distribution of the brightness of each area. Next, is an example of the AWB process. The CPU 39 determines a subject color and a light source color based on the distribution of the brightness of each area, and determines control values of AWB corresponding to the light source color. The AE and AWB processes are continuously performed while the finder mode, which displays image data on the LCD 15, is running. In case the digital camera 100 captures image date of a subject, the corresponding AF evaluation value, AE evaluation value, and AWB evaluation value are stored in a file with the captured image data.

In the finder mode, RGB signals, which are output from the imaging sensor 26 after terminating AF process and inputted to the sensor I/F 33, are stored in the SDRAM 27 by the memory controller 34. In FIG. 3, RGB signals are shown as “RAW-RGB.”

The memory controller 34 reads the RGB signals from the SDRAM 27, and outputs the RGB signals to the YUV conversion block 37. The YUV conversion block 37 converts the RGB signals to YUV signals, and outputs the YUV signals to the memory controller 34. YUV signals are stored in the SDRAM 27 by the memory controller 34. In FIG. 3, YUV signals are shown as “YUV.” The purpose of converting the YUV signals is to be able to reduce a storage volume as compared to RGB signals, and to reduce a complexity of a conversion to video signals for displaying on the LCD 15. YUV signals are read out by the memory controller 34, and displayed on the LCD 15 via the display controller 35. In this description, if RGB signals and YUV signals are not distinguished, they are referred to as image data.

The display controller 35 converts YUV signals to video signals which are, for example, NTSC signals or PAL signals. In the finder mode, a process which converts from RGB signals to video signals is performed periodically, for example in intervals of 1/30 second. The screen of the LCD 15 is updated periodically, for example, every 1/30 second. The resize process block 36 is a process block for digital zooming and magnifies or shrinks image data of YUV signals by an interpolating process. If users operate digital zooming, the resize process block 36 cuts down YUV signals, and resizes image data. If the user selects a video recording, the digital camera 100 can store a sequence of YUV signals as a moving image in the memory card 47. A recording format of the moving image is compliant with a standard format, such as an AVI or JPEG format. In addition, when compression of the moving image is selected, the compress/decompress block 38 compresses the data of the moving image.

When a user captures a still image, the user pushes the release button 12 halfway to perform an AF operation before capturing. Then, a still image starting signal by operating the operation unit 44 is inputted to the CPU 39. The CPU 39 controls the motor driver 25 coincident with frame rate to drive the imaging lens 23 and executes contrast AF, which detects a contrast of the still image while moving the imaging lens 23 step by step. In case an AF range extends from an infinite distance to a close distance, the imaging lens 23 moves to each focus position from the close distance to the infinite distance or from the infinite distance to the close distance. The CPU 39 reads out an AF evaluation value at each focus position (and optionally at each frame rate) as provided by the sensor I/F 33. The CPU 39 determines a focus lens position at which the AF evaluation value hits a peak as the in-focus position, controls to move the imaging lens 23 to the in-focus position, and controls to display a light indicating a completion of AF processing, for example on the optical finder 14. After this, users can push the release button 12 the rest of the way (i.e., fully depressed) and capture a still image.

The CPU 39 detects the fully depressed release button 12 from the operation unit 44, informs the image sensor 26, and outputs RGB signals of the still image to the signal process IC 32. As in the finder mode, the YUV conversion block 37 converts RGB signals to YUV signals, and the memory controller 34 stores the YUV signals output by the YUV conversion block 37 in the SDRAM 27. The memory controller 34 outputs YUV signals to the compress/decompress block 38, the compress/decompress block 38 compresses the YUV signals, and the memory controller 34 stores the YUV signals from the compress/decompress block 38 to the SDRAM 27 again.

The digital camera 100 of the present embodiment may use many kinds of compression formats, for example, the JPEG compression format. The memory controller 34 reads out compressed image data from the SDRAM 27, and stores image data in the NVRAM 42, or the memory card 47 via the memory card socket 41.

JPEG image data is stored in Exif format. Exif format is a format which includes information about image data or capturing parameters in one file. For example, Exif format includes information such as a captured time and date, a camera model name, a shutter speed, an aperture, information regarding the compression mode of the image data, a color space, and the number of pixels. In addition, in this embodiment, Exif format includes scene information.

The digital camera 100 has various capturing modes that can be selected by turning the capture/play switching dial 11. For example, a user can select a moving image capturing mode or a still capturing mode. If a user selects the moving image capturing mode, a microphone 46 becomes active and voices collected by the microphone 46 are converted to electrical signal by the voice process block 43.

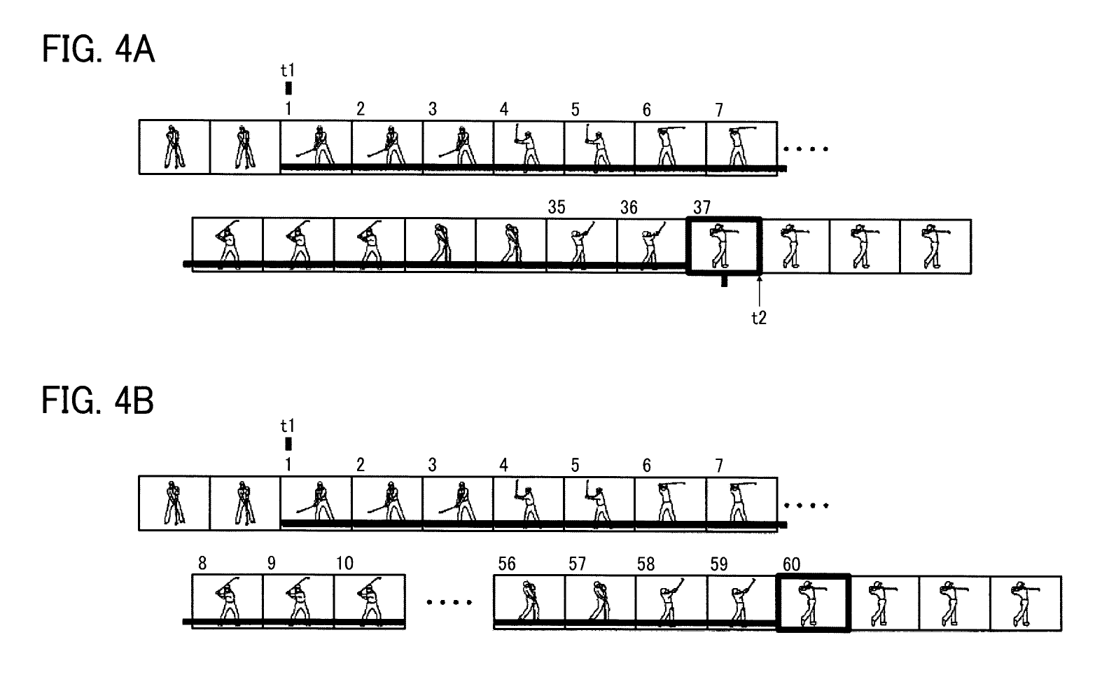

Also, the voice process block 43 compresses voices in an audio codec format, such as of WAVE or PCM, and stores the compressed voices with a corresponding moving image in a moving image format file, for example as an AVI file. Also, there are a continuous capturing mode, a high-speed continuous capturing mode, a multi-continuous capturing mode, and a multi-sized image recording mode as various capturing modes. FIG. 4A and FIG. 4B illustrates examples of continuous and high-speed continuous capturing modes of the digital camera 100. In the continuous capturing mode, the digital camera 100 continuously captures successive images while the user continues to depress the release button 12. As shown in FIG. 4A, if the user fully depresses the release button 12 at time t1 and releases the release button 12 at time t2, the digital camera 100 captures a sequence of still images from time t1 to time t2 in the continuous capturing mode.

In the high-speed continuous capturing mode, the digital camera 100 continuously captures from 60 to 120 photos during a period of one to two seconds, after the user fully depresses the release button 12. As shown in FIG. 4B, if the user fully depresses the release button 12 at time t1, the digital camera 100 captures a sequence of many photos (for example, 60 to 120 photos) during a short period of time (for example, one to two seconds).

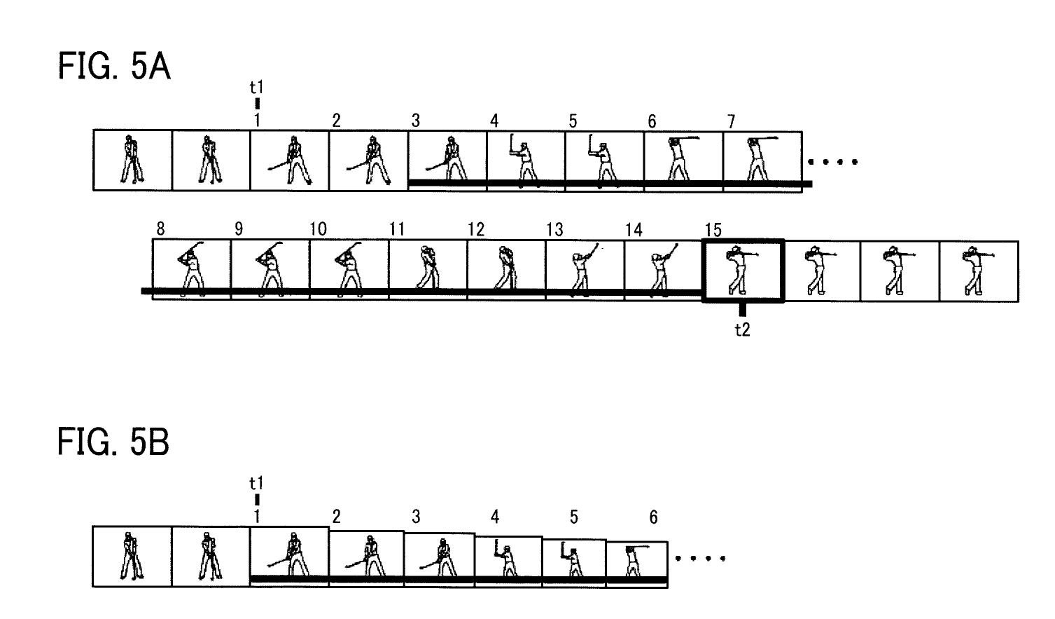

In the multi-continuous capturing mode, the digital camera 100 continuously captures a sequence of several photos (for example, 15 to 30 photos) during a short period of time (for example, one or two seconds) immediately prior to when the user releases the release button 12. As shown in FIG. 5A, if the user fully depresses the release button 12 at time t1 and releases the release button 12 at time t2, the digital camera 100 captures 15 photos in the time period immediately preceding time t2.

In the multi-sized image recording mode the digital camera 100 continuously captures photos of different image sizes during a period of time lasting one to two seconds after the user fully depresses the release button 12. As shown in FIG. 5B, if the user fully depresses the release button 12 at time t1, the digital camera 100 continuously captures photos of different image sizes. The different image sizes are predetermined, and are, for example, 3648×2736, 3648×2432, 2736×2736, 3648×2048, 2592×1944, 2048×1536, 1728×1296, 1280×960, 640×480. Images in the multi-sized image recording mode are obtained by, for example, the sensor I/F 33 adjusting a size of the image data captured by the imaging sensor 26, or by using the resize process block 36 to magnify or shrink the image data.

Also, in the high-speed continuous capturing mode, the multi-continuous capturing mode, and the multi-sized image recording mode, the plural captured photos are stored together as one file in the NVRAM 42 or the memory card 47. Therefore, users can easily handle the plural captured photos.

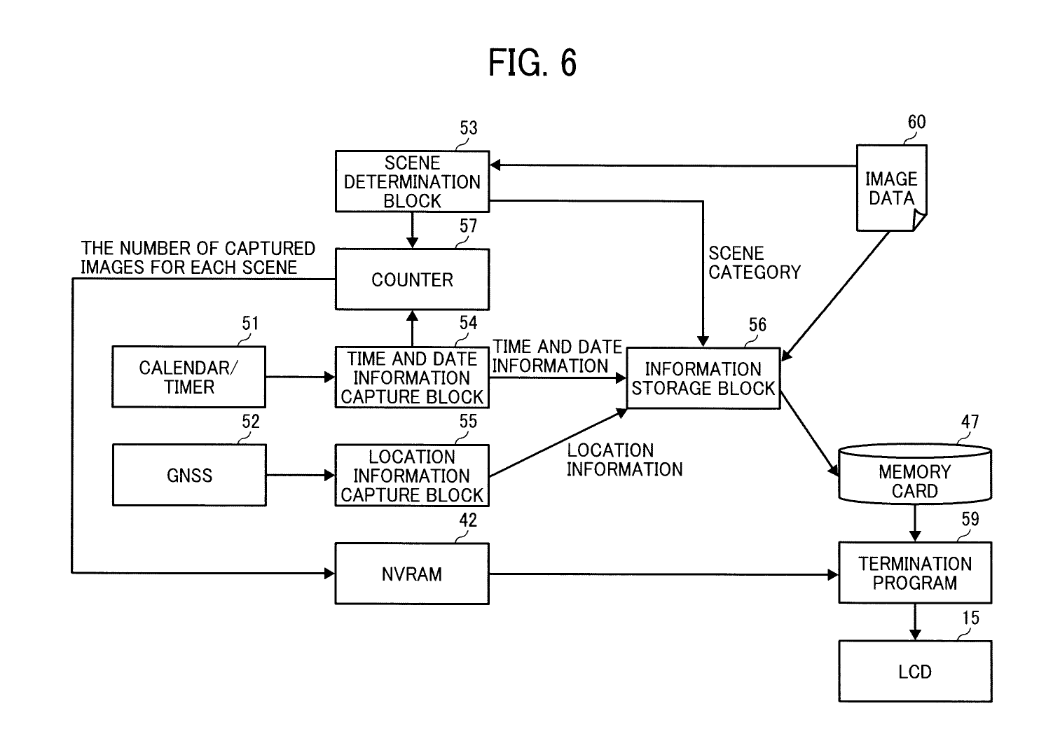

FIG. 6 illustrates a block diagram showing functions performed by the digital camera 100. The digital camera 100 has a scene determination block 53, a time and date information capture block 54, a location information capture block 55, an information storage block 56 and a counter 57. The CPU 39 executes the program 48 to perform these functions.

The scene determination block 53 determines a scene category of each captured image. The scene category is determined based on the user's settings and an analysis of the image data. The digital camera 100 stores predetermined capturing conditions that are optimized for different scene modes such as: portrait, night portrait, sports/action, distant view, zoom/close-up view, pet, and character (e.g., book or text image) scene modes. Therefore, if the user selects, using operation unit 44, a scene mode for capturing an image, the scene determination block 53 can determine a scene category for the captured image based on information of the user's selected scene mode from the operation unit 44.

Also, in an auto scene setting mode, in which the digital camera 100 automatically determines a scene category and sets appropriate capturing conditions, the scene determination block 53 analyzes image data 60 and determines a scene category. Such a method of auto scene detection is well known to persons having ordinary skill in the art. For example, auto scene detection is disclosed in Japanese Publication No. 2001-330882, Japanese Publication No. 2004-214760, Japanese Publication No. 2000-333045, or Japanese Publication No. 2009-225252.

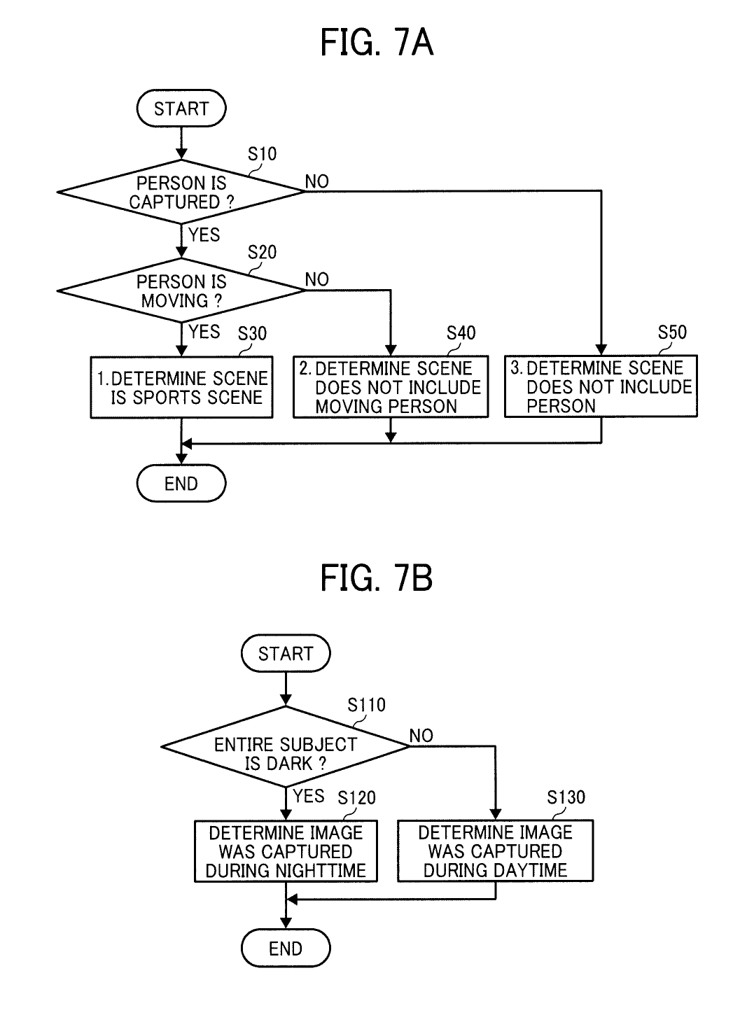

FIG. 7A and FIG. 7B are flowcharts illustrating examples of a scene determination function of the digital camera 100. FIG. 7A and FIG. 7B, show a determination function of the digital camera 100 that determines if a person is captured or if a nighttime scene is captured, as examples, and determination of other scene categories and determination with different sequence or order of operation is also included within the present invention. Also, the digital camera 100 may continuously determine a scene category not only when capturing image data but also in the finder mode.

As shown in FIG. 7A, the scene determination block 53 determines if a person is captured (S10). The determination that a person is included in the image may be based on whether a face of a person is detected. For example, the scene determination block 53 may detect a face of a person by performing a template matching function that uses brightness pattern templates of an eye and a nose of the face, and image data 60 of YUV signals. As the face size of in the image data 60 is not known, the digital camera 100 may include brightness pattern templates of different sizes.

Also, the scene determination block 53 can detect a person by using a continuous comparison of two image data 60 during finder mode, based on feature amounts of a moving subject. The scene determination block 53 determines that a subject is moving based on a difference in the YUV signals of two image data 60. The scene determination block 53 can determine a speed of the moving subject based, in part, on the difference between the two image data 60. In addition, the scene determination block 53 can calculate a bounding rectangle of a moving subject. If an aspect ratio of the bounding rectangle is almost the same as a predetermined aspect ratio threshold of a person, or if a moving speed of the moving subject is almost the same as a predetermined moving speed threshold of a person, the scene determination block 53 can determine that a person is captured in the image even if it is not able to detect the face of a person.

The scene determination block 53 calculates a determination value of a person to evaluate an accuracy of detecting the person. For example, the scene determination block 53 calculates a degree of coincidence by template matching, a degree of coincidence which the circumscribed rectangle and a moving speed of the moving subject that coincides with an average value for a person, and stores, with image data 60, these degrees of coincidence as the determination value in one file of the information storage block 56.

Also, image data concerning a number of faces captured is of interest to users. The scene determination block 53 counts the number of detected faces when the faces of persons are detected, and stores the number as the determination value, with image data 60, in one file of the information storage block 56.

If the scene determination block 53 determines a person is not captured (S10 NO), the scene determination block 53 determines that a scene does not include a person (S50).

If the scene determination block 53 determines a person is captured (S10 YES), the scene determination block 53 determines if the person is moving (S20). For example, the scene determination block 53 can use a value of an integral output by a high-frequency component extraction filter, which is included in the AF evaluation value, to determine if a person is moving. If a person is moving, edge parts of the person blur and high-frequency components hit a peak. Therefore, the scene determination block 53 can determine if a person is moving by comparing the value of the integral filter output to a threshold value.

The scene determination block 53 calculates a ratio, as a percentage, of the value of the integral and a threshold value. The ratio represents a determination value that indicates an accuracy of the determination concerning whether a person is moving or not. The determination value is stored together with the image data 60 in a single file in the information storage block 56.

If the scene determination block 53 determines a person is moving (S20 YES), the scene determination block 53 determines a scene is a sports scene (S30). If the scene determination block 53 determines a person is not moving (S20 NO), the scene determination block 53 determines a scene does not include a moving person (S40).

Next, as shown in FIG. 7B, the scene determination block 53 determines if the entire subject is dark (S110). In this example, the entire subject refers to the entire image data 60 of the captured image. The scene determination block 53 can use the AE evaluation value and an exposure time for the captured image. The AE evaluation value is a RGB value of an integral of the image data 60, therefore, the scene determination block 53 determines if the entire subject is dark by comparing an overall brightness (RGB integrated value) of the image data 60 to a threshold value. Also, the scene determination block 53 can determine if the entire subject is dark, when the exposure time is under a threshold value.

The scene determination block 53 calculates a ratio, as a percentage, of an overall brightness (RGB integrated value) of the image data 60 and a threshold value. The ratio represents a determination value that indicates an accuracy of the determination concerning whether the entire subject is dark or not. The determination value is stored together with image data 60 in one file of the information storage block 56.

If the scene determination block 53 determines the entire subject is dark (S110 YES), the scene determination block 53 determines the image was captured during nighttime (S120).

If the scene determination block 53 determines the entire subject is not dark (S110 NO), the scene determination block 53 determines the image was captured during daytime (S130). Also, the scene determination block 53 may determine not only if an entire subject is dark but also if a background of a subject shows a sunset by comparing the background of the subject to a normal RGB value of an integral value of sunset image.

As another example, the scene determination block 53 may determine that an image includes a particular kind of subject like a prepared food dish, also known as a cooking scene. In this example, the scene determination block 53 determines an image includes a prepared food dish or cooking scene by comparing feature amounts in the image to predetermined feature amounts. For example, histograms of RGB values of an integral may indicate a predetermined feature amount and may be used as a template of a prepared food dish subject in the image data. The scene determination block 53 calculates a percentage degree of coincidence of feature amounts as the determination value. The determination value indicates an accuracy of the determination concerning whether the image includes a cooking scene or not. The determination value is stored with the image data 60 in one file in the information storage block 56.

Also, the scene determination block 53 can determine if a captured image includes characters or text, for example as in an image of a book or a business card. In particular, the scene determination block 53 can determine the captured image includes characters or text as in a book or a business card, when it finds the image data 60 includes many black and white pixels and white arranged in regular patterns (for example, arranged in straight lines)

The scene determination block 53 performs an edge process using a height and a width of a character to determine an area of the image that includes black and white pixels arranged in regular patterns. The scene determination block 53 calculates a percentage ratio of the area of the image that includes black and white pixels arranged in regular patterns and the total area of the image. The ratio represents a determination value that indicates an accuracy of the determination concerning whether or not the image includes characters as in a book or a business card. The determination value is stored together with image data 60 in one file of the information storage block 56. As a result, the scene determination block 53 can determine whether the image includes a sports scene (nighttime or daytime), a landscape scene (nighttime or daytime), a portrait scene (nighttime or daytime), a prepared food dish (i.e., cooking scene), and/or a character (i.e., book or business card) scene. In addition, a single captured image may be determined to be classified into plural scenes. In this case, the scene determination block 53 classifies image data 60 as corresponding to the scene having the highest degree of accuracy, based on the determination value of the scene. The scene determination block 53 stores the determined scene category classification results with the image data 60 in one file of the information storage block 56. Therefore, each file includes the determination value for each scene category as well as an indication of which scene category was determined to correspond to the image data 60.

In addition, image data 60 may be classified to correspond to a scene category based on a product strategy of the digital camera 100. In this case, the scene determination block 53 may classify image data 60 into a scene category based on the determination value of each scene.

In case of a moving image, the scene determination block 53 extracts some image data from plural portions of the moving image, determines a scene category for each of the plural portions of the moving image, and classifies the moving image into a scene category for which an average value of the determination values for the plural portions is highest.

As shown in FIG. 6, the time and date information capture block 54 gets current time and date information from a calendar/timer 51 when a user depresses the release button 12. Time and date information includes a date, a day of the week, and a time of day, for example, Dec. 21, 2010, Tuesday, at 12:34. The time and date information capture block 54 outputs the time and date information to the information storage block 56.

The location information capture block 55 gets location information, including information regarding a current location of the camera (for example a latitude, a longitude, and an altitude), from a GNSS (Global Navigation Satellite System) 52 when YUV signals are stored in the SDRAM 27. The location information capture block 55 outputs the location information to the information storage block 56.

The information storage block 56 stores scene category, time and date, and location information when an image data 60 is stored in Exif format. Therefore, image data 60 and the information including the scene, the time and date, and/or the location information, are stored in one file. In FIG. 6, image data 60 is also stored in the memory card 47, and may be stored in the NVRAM 42.

The counter 57 counts the number of times an image corresponding to each scene is captured during various periods of time. Also, a termination program 59 is a program which performs a termination process at shut-down, including a process to display the number of captured images on the LCD 15. The process to display the number of captured images on the LCD 15 may be included in the termination program 59, or may be included in another program, for example, a program which is called from the termination program 59.

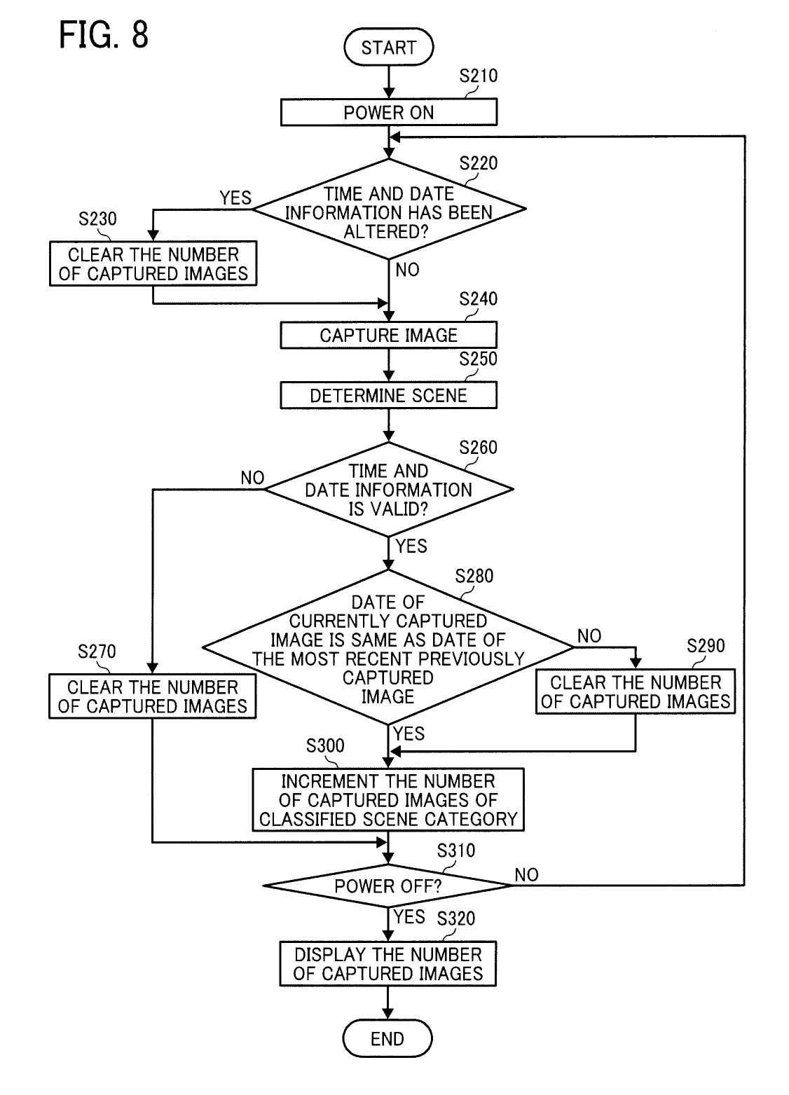

FIG. 8 is a flowchart illustrating an example of displaying the number of images captured in one day. In particular, FIG. 8 shows procedures in which the counter 57 counts the number of images captured and the termination program 59 displays the number of the captured images of each scene category in one day on the LCD 15.

The digital camera 100 is powered on (S210). If a user alters the calendar/timer 51, the wrong count values may be indicated for different periods of time. In part, for this reason, the counter 57 determines if the time and date information of the calendar/timer 51 has been altered (S220). If the counter 57 determines that the time and date information of the calendar/timer 51 has been altered (S220 YES), the counter 57 clears the total number of captured images and the number of captured images in each scene category (S230). In other words, when time and date information of the calendar/timer 51 is altered during a period of time from power-on of the digital camera 100 to power-off of the digital camera 100, the counter 57 clears the number of captured images, and the counter 57 restarts to count the number of captured images starting with the next captured image.

Next, the digital camera 100 captures an image (s240). The scene determination block 53 determines which scene category corresponds to the image from the image data 60 (S250) and outputs a result of the determination to the counter 57 and the information storage block 56. Then, information storage block 56 can store the image data 60 as a file.

Next, the counter 57 determines if time and date information of the calendar/timer 51 is valid (S260). Time and date information is valid if the time and date information has been set to a value other than the default or initial value set at manufacturing time. For example, the counter 57 determines if time and date information is back to an initial value due to an exhausted battery, or if time and date information has been set more than one time after shipping from the factory.

The counter 57 stores the factory set initial value of time and date information, and can determine, by using a flag, if time and date information has been set more than one time since being shipped from a factory.

If the counter 57 determines time and date information of the calendar/timer 51 is not valid (S260 NO), for example in case time and date information of the calendar/timer 51 has not been set on the digital camera 100, the counter 57 cannot count the number of images captured because there is no time and date information for the image data 60. Therefore, the counter 57 clears the number of captured images(S270), and does not continue to count the number of captured images.

If the counter 57 determines time and date information of the calendar/timer 51 is valid (S260 YES), the counter 57 determines if the date of a currently captured image is the same as the date of the mcst recent previously captured image (S280).

The digital camera 100 always stores the time and date information of the most recently captured previous image in the NVRAM 42, and updates the information each time an image is captured. The time and date information for an image is retrieved from the calendar/timer 51, which always has the current time and date, and the current time and date of capturing an image is stored with the image data.

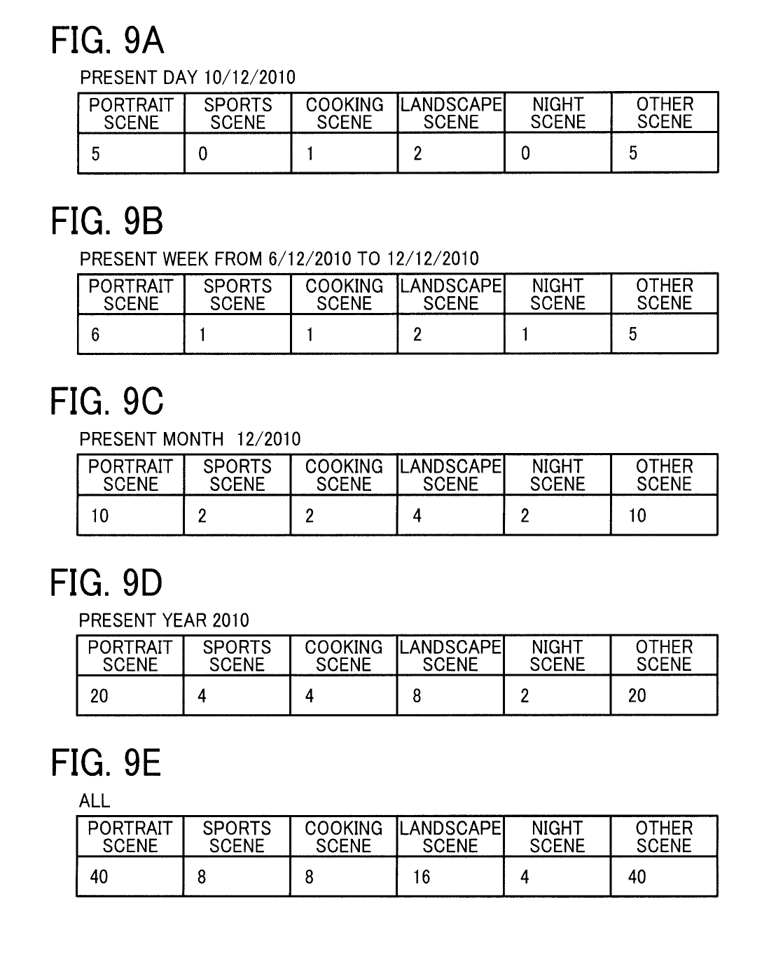

FIGS. 9A to 9E illustrate diagrams showing examples of count values in a memory of the digital camera 100. In particular, FIGS. 9A to 9E show count values of each scene in the NVRAM 42. FIG. 9A shows count values of each scene in one day, as shown on that day (i.e., today or the present day). As shown in FIG. 9A, the table title “PRESENT DAY Oct. 12, 2010” indicates that the table below shows counts of images captured during the present day (i.e., today).

If the counter 57 determines the date of a currently captured image is the same as the date of the most recent previously captured image (S280 YES), the counter 57 does not clear the number of images captured. Therefore, even if a user turns the power of the digital camera 100 on and off several times during the same day, the digital camera 100 can still display the cumulative number of images captured during that same day.

If the counter 57 determines the date of a currently captured image is not the same as the date of the most recent previously captured image (S280 NO), in other words, in case the counter 57 determines the digital camera 100 captures the first image after the current date changes (i.e., the first image of a new day), the counter 57 clears the number of captured images (S290).

In this case, the captured image is the first image captured of the new day. Here, as shown in FIGS. 9B to 9E, the digital camera 100 is able to count the number of images captured not only during a present day but also during a present week, a present month, a present year, and all time. Therefore, in the same way that the counter 57 determines if the date has changed, as described above, the counter 57 determines if a week has changed (i.e., the week of the currently captured image is different than the week of the most recently captured previous image). If a week has changed, the counter 57 determines if a month has changed. If a month has changed, the counter 57 determines if a year has changed.

Also, if a week has changed, the counter 57 clears the number of images captured during the present week. If a month has changed, the counter 57 clears the number of images captured during the present month. If a year has changed, the counter 57 clears the number of images captured during the present year.

If the counter 57 determines a date of a currently captured image is the same as the date of the most recent previously captured image (S280 YES), the counter 57 increments the number of captured images of a classified scene category (S300). Therefore, the counter 57 increments the numbers of captured images of a classified scene category in a present day, a present week, a present month, a present year, and for all time.

According to the method used for counting, the counted number of images captured for a classified scene category in a present day, a present week, a present month, a present year, and all time are redundantly incremented. Therefore, if the digital camera 100 displays the number of images captured in a present week, the digital camera 100 can also provide the number of images captured in a present week including a present day. If the digital camera 100 displays the number of images captured in a present month, the digital camera 100 can also provide the number of images captured in a present month including a present day. If the digital camera 100 displays the number of images captured in a present year, the digital camera 100 can also provide the number of images captured in a present year including a present day. If the digital camera 100 displays the number of images captured during the different predetermined periods of time, the digital camera 100 can also provide the number of images captured during the present day.

In addition, in the step of S220, in case time and date information is altered, the numbers of images captured for only the present day are cleared, because the camera can determine that the numbers of images captured were incremented when the camera was in a state of having correct time and date information set to the calendar/timer 51.

The digital camera 100 may be configured to determine how to count the number of images captured in case of using a capturing mode that captures plural images each time the release button is depressed. In this embodiment, users can configure the method used by the digital camera 100 to count the number of captured images. For example, a user can configure the digital camera 100 to select whether or not images captured using the continuous capturing modes are counted. The user's desired configuration of the digital camera 100 is stored in the NVRAM 42, and it is output as a parameter to the counter 57.

In case the user configures the digital camera 100 so that images captured using the continuous capturing modes are counted, the counter 57 counts the number of images captured corresponding to the continuous capturing modes. The method of determination of a scene is the same as the method of FIG. 7A and FIG. 7B. Next, an example will be described regarding the continuous capturing modes. In case of the continuous capturing modes or multi-sized image recording mode, the counter 57 counts the number of images captured after the user depresses the release button 12, by using, for example, the number of times which the sensor I/F 33 captures RGB image data based on VD signals, the number of times YUV signals are converted, or the number of times image data is stored in the SDRAM 27. In case of the multi-continuous capturing mode, the counter 57 does not need to count because the number of images captured is predetermined. In multi-continuous capturing mode, the counter 57 increments by a predetermined number(for example, 15 or 26) after the user releases the release button 12. In case of the moving image mode, it is possible to extract some still images from the moving image. However, the counter 57 counts one moving image as one captured image even if some still images are also extracted from the moving image. In case of recording voices, in the moving image mode, voices are recorded, too. Also, the digital camera 100 can record voice data with a still image. Therefore, the counter 57 can count a still image recorded with voice data as a single captured image.

The counter 57 increments for a present day, a present week, a present month, a present year, and all time, as shown in FIGS. 9A to 9E, and each time an image is captured a stored date and time of the last image captured is updated.

The CPU 39 determines if the digital camera 100 is powered off (S310). During the time that the CPU 39 determines the digital camera 100 is not powered off (S310 NO), until the digital camera 100 is powered off, the counter 57 repeats the process of from S220 to S300. Therefore, if time and date information is valid and a date of a currently captured image is the same as the date of the most recently captured previous image, the counter 57 is incremented to count the number of images captured in the present day.

If the CPU 39 determines that the user has selected to power-off the digital camera 100 (S310 YES), the counter 57 reads out the number of images captured from the NVRAM 42, and displays the number of images captured during the current day on a termination screen displayed on the LCD 15 as the camera transitions from being powered-on to being powered-off (S320). In this way, the digital camera 100 can display the number of images captured in each scene category, as shown in FIG. 1.

The user selects to power-off the digital camera 100 by pressing the power button 13. The CPU 39 detects the operation by an interrupt process. The CPU 39 performs a termination process, which records setting information of the capturing condition and displays the termination screen, due to the interrupt process. In this embodiment, for example, the termination program 59 performs the termination process, and displays the number of images captured of each scene category on the termination screen.

In addition, if time and date information is not set to the digital camera 100, the number of images captured is 0 (zero). Therefore, the termination program 59 displays the number of images captured as (zero) on the termination screen. The digital camera 100 displays the number of images captured, as shown In FIG. 1, for a short period of time (for example, one or two seconds), prior to the camera becoming automatically powered off.

As mentioned above, the digital camera 100 can store time and data information of the last image captured, and can increment the number of images captured during the same day by comparing a date of a currently captured image to the stored date information of the most recently captured previous image, and display the number of images captured on the termination screen when the digital camera 100 is powered off.

In addition, the digital camera 100 can display the number of images captured on not only the termination screen but also on a screen displayed during the play mode. A user may switch the capture/play switching dial 11 to the play mode and operate the operation unit 44, for example, to have the counter 57 retrieve the number of images captured from the NVRAM 42 and display the number of images captured on the LCD 15. In this way, a user can know the number of images captured of each scene category at any time.

### The Second Embodiment

In the first embodiment, the digital camera 100 displays the number of images captured of each scene category with a scene name and an icon. In this embodiment, the digital camera 100 displays a shrunken image of image data that corresponds to the scene name. In this way, users can easily know what subjects were captured in each scene category.

The configuration of the digital camera 100 is the same as the first embodiment, and hence redundant explanation is skipped in the following description. When the digital camera 100 displays the number of images captured of each scene category on the termination screen, the termination program 59 of this embodiment reads out representative image data from the memory card 47, and displays a reduced size copy of the corresponding representative image on the termination screen for each scene category.

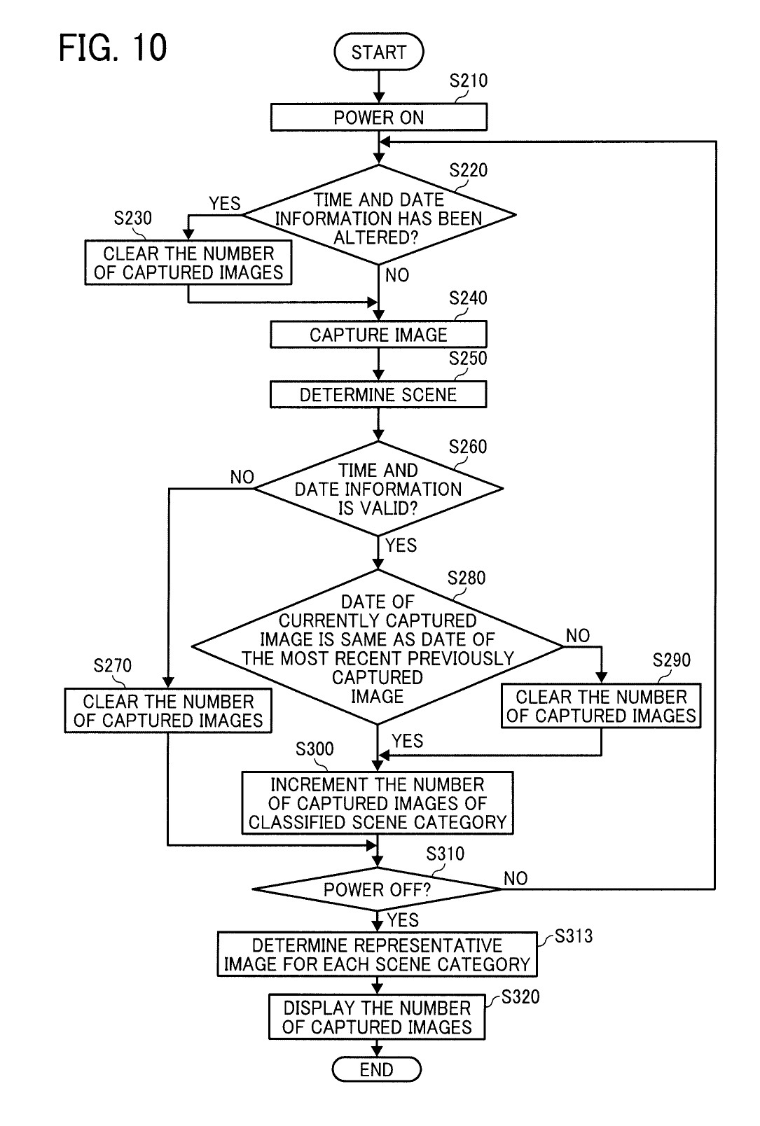

FIG. 10 is a flowchart illustrating another example of the operation of displaying the number of images captured in one day. FIG. 10 shows procedures for displaying the number of images captured of each scene category in one day on the LCD 15. FIG. 10 is almost the same as FIG. 8, but in the step of S310, the procedures after the user selects to power-off the digital camera 100 are different.

If the CPU 39 determines the user has selected to power-off the digital camera 100 (S310 YES), the termination program 59 determines a representative image for each scene category (S313). With respect to determination methods of representative image, there are, for example, the methods to determine a representative image can be made by selecting image data indicating a greatest AF evaluation value, a greatest S/N ratio, or by selecting image data having the greatest number of detected faces. In addition, it may take a long time to determine a representative image after the user selects to power-off the digital camera 100. Hence, the digital camera 100 can determine representative images when image data is stored in the memory card 47 or the NVRAM 42. The termination program 59 applies these methods to each scene category, and determines a representative image for each scene category.

In addition, the S/N ratio may be calculated in many different ways as known by a person having ordinary skill in the art. Thus, for example, the termination program 59 can calculate the S/N ratio of image data based on the average brightness and/or a size of the brightness dispersion.

A high AF evaluation value corresponds to sharp image data. Therefore, in case the termination program 59 determines that a representative image corresponds to the sports scene category or the cooking scene category, the AF evaluation value can be used as an index to select the representative image. The termination program 59 reads out the image data for which the AF evaluation value is highest in image data corresponding to the sports scene category or the cooking scene category.

The S/N ratio affects image quality in all scene categories. The S/N ratio affects image quality especially in the night scene category. Hence, for the night scene category, the termination program 59 reads out image data having a highest S/N ratio.

A high number of detected faces in an image corresponds to a large number of persons being captured in a portrait scene. Therefore, in case the termination program 59 determines a representative image is in the portrait scene category, the number of detected faces is used as an index. The termination program 59 reads out image data for the image having the largest number of detected faces for the portrait scene category.

In addition, in image data of the landscape scene category, the termination program 59 determines image data for which the sum of the AF evaluation value and the S/N ratio is largest, as the representative image.

Also, there is a method for determining the representative image based on the determination value of each scene category. The above mentioned image data has a determination value for each scene category. The determination program 59 can determine a representative image with reference to the determination value of each scene category. For example, in image data of the portrait scene category, the determination program 59 reads out image data for which the determination value is highest in image data of the portrait scene. In image data of the sports scene category, the determination program 59 reads out image data for which the determination value is highest in image data of the sports scene. In image data of the landscape scene, the determination program 59 reads out image data for which the determination value is highest in image data of the landscape scene. In image data of the night scene, the determination program 59 reads out image data for which the determination value is highest in image data of the night scene.

The determination program 59 shrinks a determined representative image to a predetermined size and displays the reduced size image with the number of corresponding captured images of that scene category on the termination screen (S320). Therefore, using the digital camera 100 of this embodiment, users can easily know not only the number of captured images of each scene category but also a representative image of each scene category.

In addition, the digital camera 100 can display not only a representative image but also all images of each scene category, in the order they were captured. In other words, the termination program 59 reads out all images of each scene in one day, and displays each image of each scene category one by one at predetermined rate (for example, one picture every 0.5 seconds). When the last image of a category is displayed, the digital camera 100 may continue to display the last image of each scene category for an extended period of time. Therefore, users can easily know not only the number of images captured for each scene category but also what subjects were captured in each scene category.

### The Third Embodiment

In the first embodiment and the second embodiment, the digital camera 100 displays the number of images captured in one day. In this embodiment, the digital camera 100 displays the number of images captured over a predetermined period of time ending at the current time (i.e., the number of images captured over the last predetermined time period).

As shown in FIGS. 9A to 9E, the digital camera 100 can display five the number of captured images over five different periods of time: one day, one week, one month, one year, and a total of all time. In the number of images captured in one week, for example if a present day is December 10, the digital camera 100 displays the number of images captured from December 6 to now. In the number of images captured in one month, for example if a present month is December, the digital camera 100 displays the number of images captured from December 1 to now. In the number of images captured in one year, for example if a present year is 2010, the digital camera 100 displays the number of images captured from Jan. 1, 2010, to now. In a total of images captured for all time, the digital camera 100 displays the total number of captured images. But, if the digital camera 100 was reset previously, the digital camera 100 displays a total number of images captured since the resetting. The digital camera 100 can display all of five kinds of the number of captured images, too. However, the user may feel it is troublesome to display all five kinds if it takes too much time until the termination screen disappears. Hence, in this embodiment, users can select for which period of time the number of captured images should be displayed.

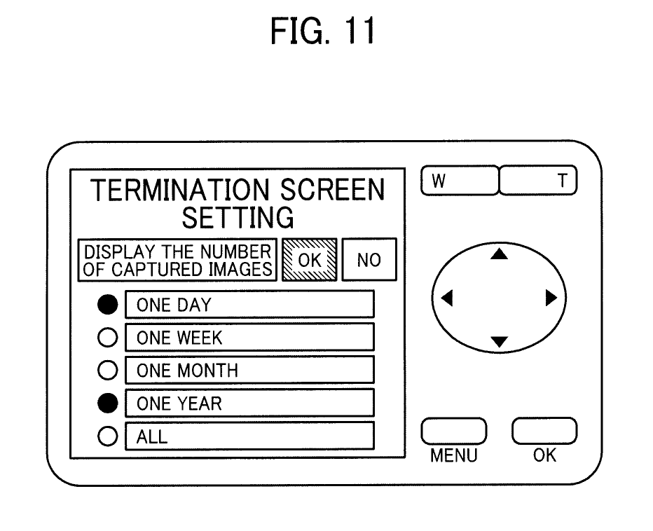

FIG. 11 illustrates a diagram showing an example of a screen which sets a period of time for counting the number of images captured. The screen is displayed on the LCD 15 by operating the operation unit 44. Users can select “OK” or “NO” for “DISPLAY THE NUMBER OF CAPTURED IMAGES”. If a user selects “OK”, the number of captured images is displayed on the termination screen according to the selected periods of time listed below. If a user selects “NO”, the number of images captured is not displayed on the termination screen, and the period of time selected below is inactive

As shown in FIG. 11, the options for a selected period of time for counting the number of images includes one day, one week, one month, one year, and total for all time. A user can set the period of time for counting the number of captured images on the termination screen by selecting radio buttons. In the example of FIG. 11, one day and one year are selected.

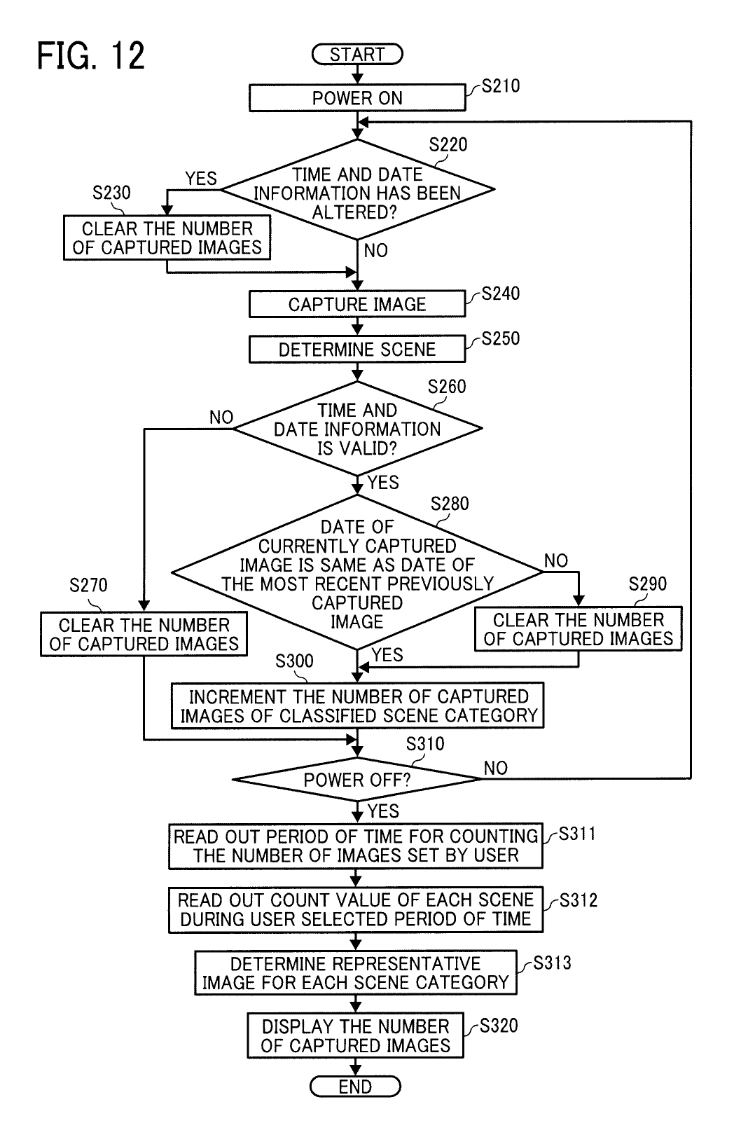

FIG. 12 is a flowchart illustrating another example of the operation of displaying the number of images captured in one day. FIG. 12 shows the number of images captured of each scene category in one day on the LCD 15. FIG. 12 is almost the same as FIG. 10, but in the step of S310, the procedure following the user selecting to power-off the digital camera 100 are different.

If the CPU 39 determines the user selects to power off the digital camera 100 (S310 YES), the termination program 59 reads out the period of time for counting the number of images set by the user (S311), and reads out count values of each scene category during the user selected period of time from the NVRAM 42 (S312).

Next, in the same way as in the second embodiment, the termination program 59 determines representative images. It is desirable to determine representative images from within image data falling within the counting period of time set by the user. Hence, the termination program 59 determines representative images of each scene category from image data falling within the period of time set by the user based on image quality or based on the determination value of each scene. In addition, the termination program 59 can determine if image data was captured during the user selected period of time for counting based on the time and date information stored with each image. However, if the termination program 59 determines representative images in each user selected period of time for counting, the user may have to wait a long time. In this case, the termination program 59, for example, may determine representative images from within image data of a present day even if the user selected period of time for counting has changed.

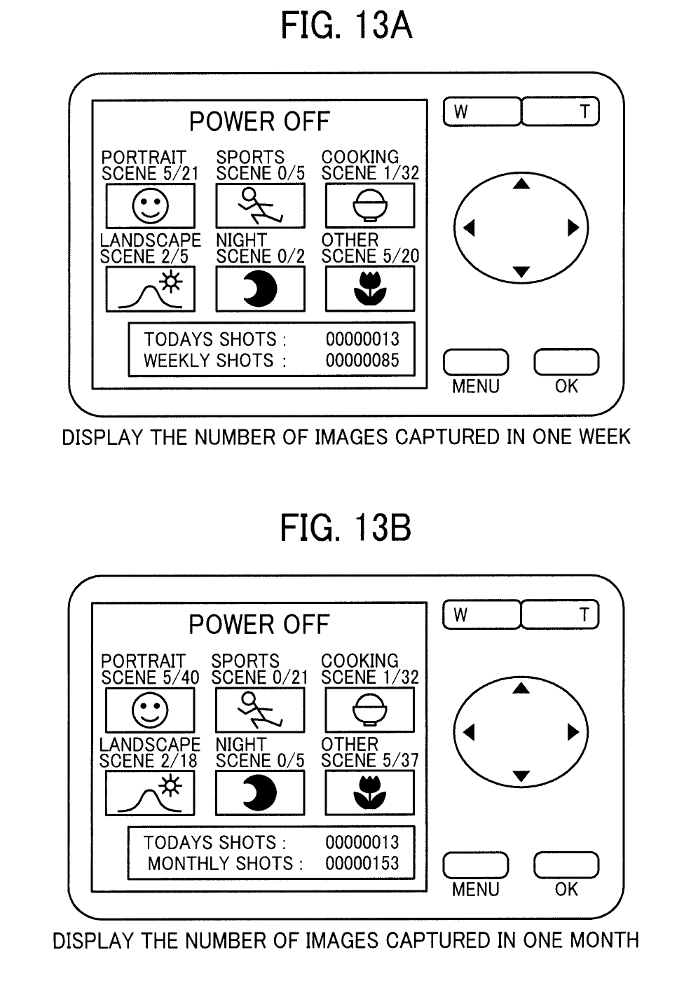

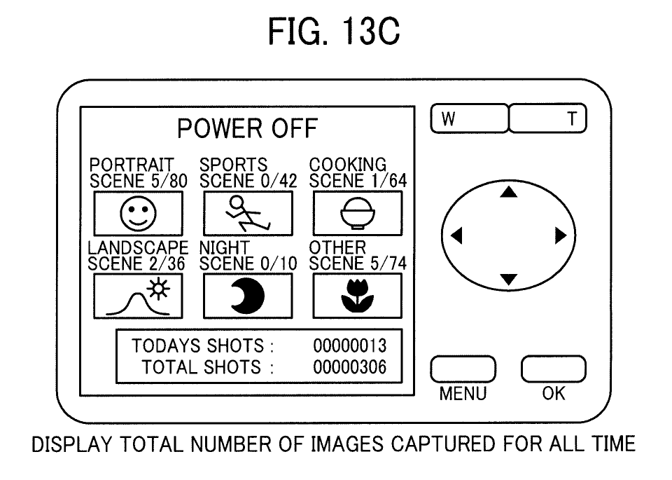

FIGS. 13A to 13C illustrate schematic diagrams showing other examples of displaying the number of images captured by the digital camera 100. FIG. 13A shows the number of images captured in one week. FIG. 13B shows the number of images captured in one month. FIG. 13C shows a total number of images captured for all time, in other counting all of the past captured images. If a user sets a period of time for counting to be one week, one month and all time, the termination program 59 shows the displays from FIG. 13A to FIG. 13C in order, and then the digital camera 100 is powered off.

Therefore, the digital camera 100 of this embodiment can display the number of images captured in a predetermined period of time ending at the current time. Also, users can set the period of time for counting the number of images captured.

### The Fourth Embodiment

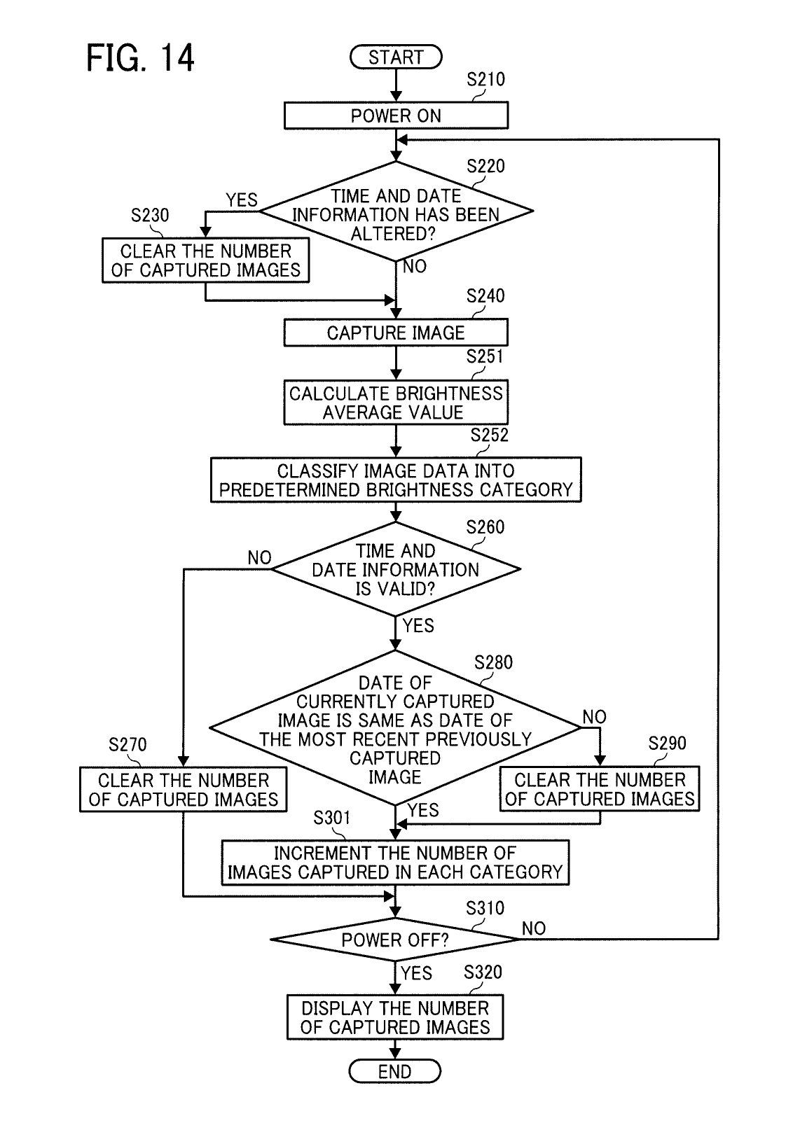

FIG. 14 is a flowchart illustrating another example of the operation of displaying the number of images captured in one day. In the first embodiment, the second embodiment and the third embodiment, the digital camera 100 displays the number of images captured in each scene category. In this embodiment, the digital camera 100 displays the number of images captured in each category, and further classifies image data into plural different brightness levels, for example three brightness levels: “bright”, “middle” and “dark”.

FIG. 14 is almost the same as FIG. 8, but the procedure after step S240 are slightly different. Therefore, the following discussion will focus on the procedure after step S240. Also, the function of the digital camera 100 is almost the same as FIG. 6. However, in this embodiment, the digital camera 100 has a category determination block 50 instead of the scene determination block 53.

After the digital camera 100 captures an image (s240), the category determination block 50 calculates a brightness average value of image data (S251). Next, the category determination block 50 classifies, by use of a threshold value, image data 60 into different predetermined characteristics of the images, such as predetermined brightness categories, for example “bright”, “middle” and “dark”, based on the brightness average value. (S252)

Steps S260 to S290 are the same as in FIG. 8, hence refer to the description associated with FIG. 8 for those steps.

Next, if the counter 57 determines a date of a currently captured image is the same as the date of the most recent previously captured image (S280 YES), the counter 57 increments the number of images captured in each brightness category, as classified in step S252 (S301).

The CPU 39 determines if the user selects to power off the digital camera (S310). If the CPU 39 determines the user has not selected to power off the digital camera 100 (S310 NO), until a time when the user select to power off the digital camera 100, the counter 57 repeats the process of steps S220 to S301. Therefore, if time and date information is valid and a date of a currently captured image is the same as the date of a most recent previously captured image, the counter 57 continues to increment the number of images captured during the present day.

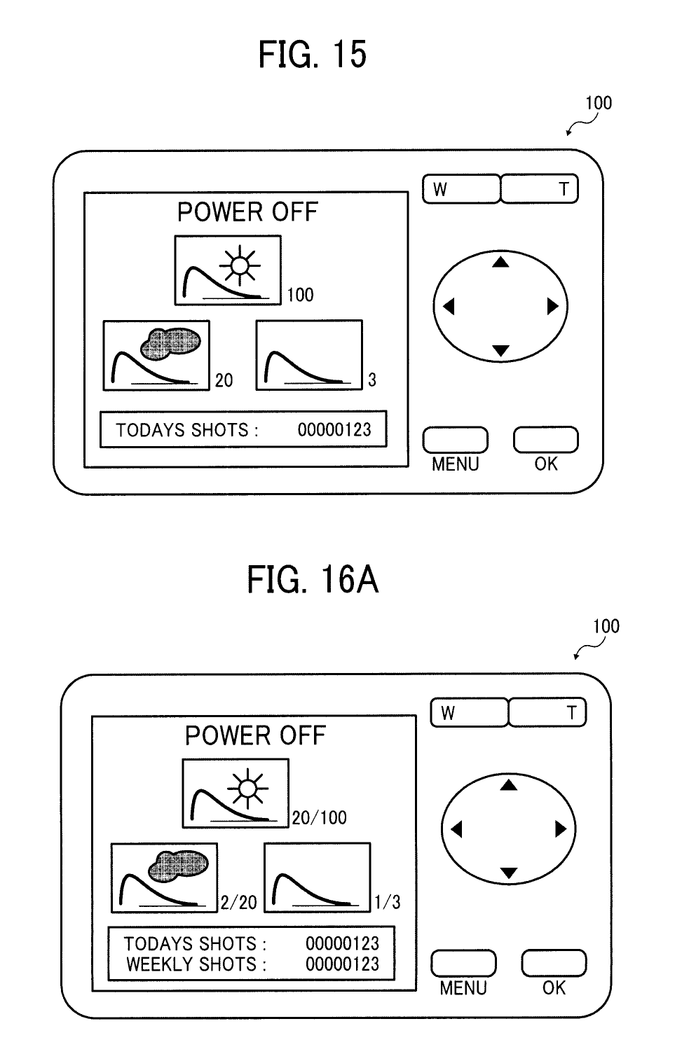

If the CPU 39 determines the user selects to power off the digital camera 100 (S310 YES), the counter 57 reads out the number of images captured from the NVRAM 42, and displays the number of images captured in one day during time when the digital camera 100 transitions from being powered-on to being powered-off on the termination screen of the LCD 15 (S320). In this way, the digital camera 100 can display the number of images captured of each brightness category (e.g., “bright”, “middle” and “dark”) in one day, as shown in FIG. 15.

Therefore, the digital camera 100 of this embodiment can classify image data based on a predetermined indicator (for example, a brightness of the image data), count the number of images captured in each category of the predetermined indicator, and display the number of images captured of each category of the predetermined indicator in one day on the terminal screen of the LCD 15. Hence, users can know the number of images captured of each category of the predetermined indicator.

In addition, in this embodiment although the brightness of image data was described as the predetermined indicator, the digital camera 100 may classify image data based on the following other predetermined indicators, listed below from the first to the third.

The first indicator concerns a capturing distance. The digital camera 100 determines a focusing point based on the AF evaluation value of each position of the imaging lens 23 in AF operation, and calculates the distance to a subject. Also, the digital camera 100 classifies, by use of one or more threshold values, the calculated distance into plural distance categories, for example “close”, “middle” and “far”.

The second indicator concerns a color of image data. The digital camera 100 divides image data into plural areas, classifies a subject color or a light source color into “red”, “blue” or “green” based on the distribution of the brightness value in the corresponding color (RGB value of integral) of each area.

The third indicator concerns a an orientation of the digital camera 100 when the image is captured. The digital camera 100 detects whether the camera is in a landscape orientation, with the longest dimension of the image arranged horizontally, or in a portrait orientation, with the longest dimension of the image arranged vertically.

Also, as shown in FIG. 15, the digital camera 100 may display a representative image of each category with the number of images captured. In this way, users can know the number of images captured and a corresponding captured scene.

As in the second embodiment, the digital camera 100 automatically determines representative images based on predetermined evaluation values. As mentioned with respect to the second embodiment, there are, for example, methods to determine representative image based on image data, such as selecting an image for which the AF evaluation value is highest, for which a S/N ratio is highest, or for which the number of detected faces is greatest. Furthermore, there is a method to determine representative images based on image data in which an accuracy level indicated by a determination value of the automatic scene recognition function is highest. These methods may be used individually or plural methods may be used in combination. Also, users may select which one or more of these methods are used.

The functions of face detection and capturing scene automatic recognition are well known and described shortly. In case a user points the digital camera 100 at a person, the function of face detection recognizes the face of the person, sets a focus and brightness automatically, and optimizes an exposure so as to capture the face of the person, based on instructions of the CPU 39.

Also, in case a user points the digital camera 100 at a person, the function of capturing scene automatic recognition recognizes a capturing scene, sets parameters which are for example an exposure value, a capturing sensitivity and white balance, and a capturing condition (for example the presence or absence of a flash), as appropriate values for the capturing scenes, based on instructions of the CPU 39.

### The Fifth Embodiment

The digital camera 100 of the fourth embodiment displays the number of images captured in one day on the termination screen, as shown in FIG. 15. In this embodiment, as in the third embodiment, the digital camera 100 displays the number of images captured in during a predetermined period of time ending with the current time.

Therefore, the digital camera 100 of this embodiment displays the number of images captured in one week, the number of images captured in one month, the number of images captured in one year and the number of images captured for all time, in other words all of the past captured images. Also, the description of this embodiment is the same as the description of the forth embodiment except for the difference of the period of time for counting, in other words the camera can count images one day or a predetermined period of time.

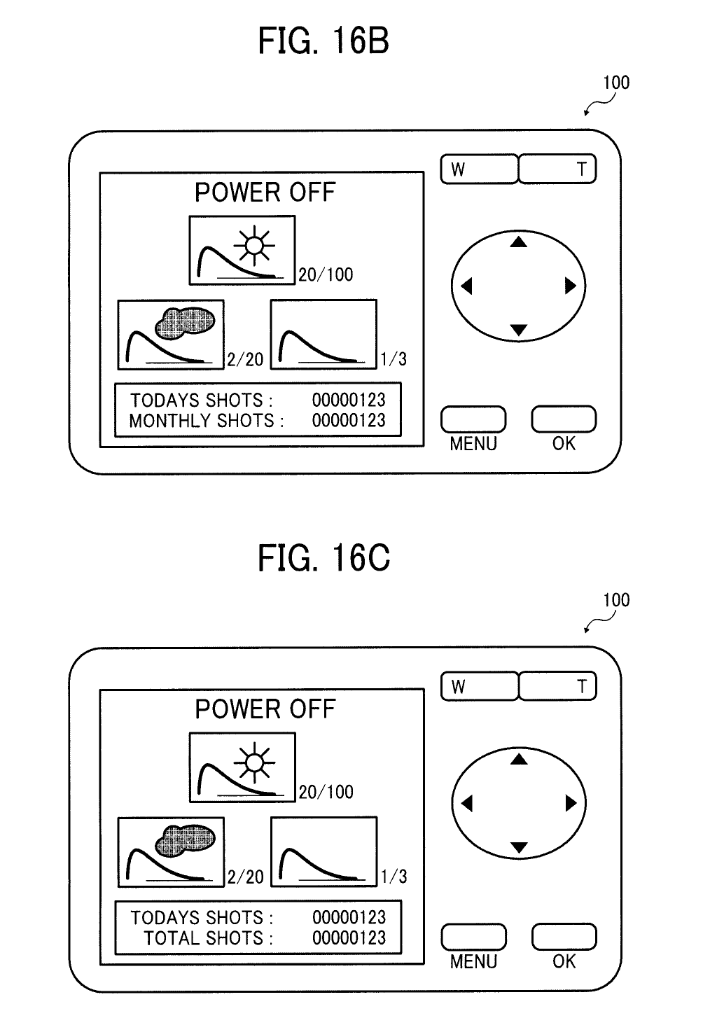

FIGS. 16A to 16C illustrate schematic diagrams of other examples of displaying the number of images captured by the digital camera 100. FIGS. 16A to 16C show the state of the termination screen, in case a user sets the period of time for capturing to be one week, one month and all time, respectively. That is, FIG. 16A shows the number of images captured in one week, FIG. 16B shows the number of images captured in one month, and FIG. 16C shows the number of images captured for all time, in other words all of the past captured images.

As shown in FIG. 11, the options of periods of time for counting include one day, one week, one month, one year, and all time. Users set the period of time for counting on the termination screen by selecting radio buttons.

If a user selects one week as the period of time for counting, as shown in FIG. 16A, the digital camera 100 displays the number of images captured in one week on the termination screen.

Here, one week starts on Sunday and ends on Saturday. The digital camera 100 displays the cumulative number of images captured from the most recent last Sunday until now. The method of counting the number of captured images in one week is basically the same as the method of counting the number of images captured in one day, as described above.

Also, in case the digital camera 100 displays the number of images captured in one day, the counter 57 clears the number of images captured in one day when a date of a currently captured image is not the same as a date of a most recently captured previous image. However, in case the digital camera 100 displays the number of images captured in one week, the counter 57 clears the number of images captured in one week when a date of a currently captured image is not the same as the date of the most recently captured previous image and the week of the currently captured image is not the same as the week of the most recently captured previous image based on time and date conditions of a day of the week of a previously captured image.

Here, time and date conditions of a day of the week of a previously captured image means that, in case a day of the week of a previously captured image is Sunday, more than seven days have passed, in case a day of the week of a previously captured image is Monday, more than six days have passed, in case a day of the week of a previously captured image is Tuesday, more than five days have passed, in case a day of the week of a previously captured image is Wednesday, more than four days have passed, in case a day of the week of a previously captured image is Thursday, more than three days have v, in case a day of the week of a previously captured image is Friday, more than two days have passed, and in case a day of the week of a previously captured image is Saturday, more than one day has passed. In this way, the counter 57 does not clear the number of images captured in one week during Monday to Saturday of the same week. Therefore, when the digital camera 100 is powered off, the digital camera 100 can display the number of images captured in one week, with Sunday as the beginning of the week.

If a user selects one month as the period for counting, as shown in FIG. 16B, the digital camera 100 displays the number of images captured in one month on the termination screen.

The way of counting the number of images captured in one month is basically the same as the way of counting the number of images captured in one day. Also, in case the digital camera 100 displays the number of images captured in one day, the counter 57 clears the number of images captured in one day when a date of a currently captured image is not the same as a date of a most recent previously captured image. However, in case the digital camera 100 displays the number of images captured in one month, the counter 57 clears the number of images captured in one month when the month of a currently captured image is not the same as the month of the most recent previously captured image. In this way, the counter 57 does not clear the number of images captured in one month during the same month. Therefore, when the digital camera 100 is powered off, the digital camera 100 can display the number of images captured in one month.

If users select all time as the period for counting, as shown in FIG. 16C, the digital camera 100 displays the total number of images captured on the termination screen.

The counter 57 does not clear the number of images captured from the time of purchase of the digital camera 100 until the current time. The counter 57 increments the number of images captured each time an image is captured. In this way, when the digital camera 100 is powered off, the digital camera 100 can display the total number of all images captured.

Therefore, when users would like to know the number of images captured with respect to one week, one month or for all time, users can know the number of images captured with respect to one week, one month or all without manually counting the number of images captured by displaying the captured images. Hence, users can easily know the number of images captured of each of plural different categories with respect to one week, one month or for all time by use of the digital camera 100 of this embodiment.

Also, in the fourth embodiment, the digital camera 100 displays the number of images captured of each category. However, in this embodiment, the digital camera 100 may display a capturing order of representative images, as shown in FIGS. 16A to 16C, with the number of images captured in each category. For example, the number “20” of “20/100” in FIG. 16A shows that the representative image is the twentieth image in 100 images, and the number “100” of “20/100” in FIG. 16A shows the number of images captured in each category. Hence, when users would like to display representative images individually, users can quickly find representative images by use of the capturing order.

Also, with respect to the first embodiment to the fifth embodiment, in case the digital camera 100 has at least one of a still image capturing function, a character image capturing function, or a moving image capturing function, the digital camera 100 may count the number of images captured when users capture an image by use of at least one of these functions.

Furthermore, with respect to the first embodiment to the fifth embodiment, in case the digital camera 100 has at least one of a continuous capturing function, a multi-size image recording function, or a bracket function, the digital camera 100 may count the number of images captured including all of some images when users capture some images by use of at least one of these functions.

As described above, the present invention provides an imaging apparatus and a method of displaying the number of images captured which can display the number of images captured of each scene category or each other predetermined category, during different periods of time.

Although the embodiments of the present invention have been described above, the present invention is not limited thereto. It should be appreciated that variations may be made in the embodiments described by persons skilled in the art without departing from the scope of the present invention.

What is claimed is:

1. An imaging apparatus, comprising:
an image capturing unit that captures image data;
a display that displays the image data; a calendar that provides current time and date information;
a determination unit that classifies the image data by determining which one of plural different scene categories corresponds to the image data;
a count unit that obtains the current time and date information from the calendar, adds the image data to the time and date information and increments a number of images captured today corresponding to the scene category classified by the determination unit when a date of a currently captured image data is the same as a date of a previously captured image data; and
a display unit that displays, on the display, the number of images captured today corresponding to each of the plural different scene categories, when a predetermined operation is performed.

2. The imaging apparatus according to claim 1, wherein the display unit determines a representative image from the captured images classified as corresponding to the scene category based on a predetermined factor, and displays the representative image with the number of images captured today corresponding to the scene category on the display.

3. The imaging apparatus according to claim 1,
wherein the count unit retains the number of the images captured today corresponding to each of the scene categories even if the imaging apparatus is powered off today, and
the display unit displays a cumulative number of images captured today for all scene categories.

4. The imaging apparatus according to claim 1,
wherein the count unit increments the number of images captured today for a scene category when the count unit detects a still image is captured or a moving image is captured that corresponds to the scene category.

5. The imaging apparatus according to claim 1, further comprising:
a continuous capturing unit that captures plural images each time a release button is depressed,
wherein the count unit increments a cumulative number of images captured today for all scene categories by the number of the plural images captured by the continuous capturing unit.

6. The imaging apparatus according to claim 1, further comprising:
a voice recording function that optionally records voice data with a captured still image,
wherein the count unit increments the cumulative number of images captured today by one each time a still image is captured with the voice data by use of the voice recording function, and the count unit increments the cumulative number of images captured today by one each time an image is captured without the voice data.

7. The imaging apparatus according to claim 1,
wherein the count unit determines if the time and date information is invalid, and when the count unit determines the time and date information is invalid, the count unit clears the number of images captured today for each scene category and prevents further incrementing, and
the display unit displays zero as the number of images captured today for each scene category.

8. The imaging apparatus according to claim 1,
wherein the count unit clears the number of images captured today for each scene category when the time and date information is altered.

9. The imaging apparatus according to claim 1,
wherein the count unit clears the number of images captured today for each scene category and increments a cumulative number of images captured today for all scene categories from zero, when the date of the currently captured image data is not the same as the date in the previously captured image data.

10. The imaging apparatus according to claim 1, further comprising:
a setting unit which sets a period of time for counting to be one or more of one week, one month, one year, or for all time,
wherein the display unit displays the number of images captured in one week, the number of images captured in one month, the number of images captured in one year, and/or the number of images captured for all time according to the period of counting set by the setting unit on the display.

11. The imaging apparatus according to claim 1,
wherein the display unit displays the number of images captured today corresponding to each scene category on the display when the imaging apparatus is in a play mode.

12. The imaging apparatus according to claim 2,
wherein the display unit determines a different image from each scene category to be a representative image and displays the representative image on the display for a predetermined duration.

13. The imaging apparatus according to claim 2,
wherein the display unit sequentially displays a capturing order of the representative image with the number of images captured in each scene category.

14. The imaging apparatus according to claim 1,
wherein the display unit displays the number of images captured today corresponding to each scene category on the display when a power-off state of the imaging apparatus is selected.

15. The imaging apparatus according to claim 1, further comprising:
a category classifying unit that classifies the image data based on a predetermined indicator,
wherein the count unit counts the number of images captured of each predetermined indicator category used to classify the image data by the category classifying unit.

16. The imaging apparatus according to claim 2,
wherein the display unit determines a representative image for each scene category based on at least one of an AF evaluation value, a S/N ratio, a number of faces detected, or an accuracy level indicated by a determination value of an automatic scene recognition function.

17. The imaging apparatus according to claim 15,
wherein the predetermined indicator includes at least one of a brightness of the image data, a color of the image data, or a position of the imaging apparatus.

18. A method of displaying a number of captured images, comprising:
capturing image data by an image capturing unit;
displaying the image data by a display;
providing current time and date information by a calendar;
classifying the image data and determining which one of plural different a scene categories corresponds to the image data by a determination unit;
obtaining the current time and date information from the calendar, adding the image data to the time and date information and incrementing, by a count unit, a number of images captured today corresponding to the scene category classified by the determination unit when a date of a currently captured image data is the same as a date in a previously captured image data; and
displaying, by a display unit, the number of images captured today corresponding to each of the plural different scene categories on the display when a predetermined operation is performed.

19. An imaging apparatus, comprising:
an image storing unit that captures an image and stores the captured image with a time and date at which the images was captured;
a determination unit that determines a category of the captured image based on a content of the capture image;
a count unit that increments a stored number of images captured during a preceding period of time and corresponding to the determined category of the captured image; and
a display unit that displays the stored number of images captured during the preceding period of time and corresponding to the category of the captured image.
